(19) United States
(12) Patent Application Publication
(10) Pub. No.: US 2018/0308137 A1
(43) Pub. Date: Oct. 25, 2018

(54) PHOTOGRAPHIC EVALUATION, RATING SYSTEM, AND ASSESSMENT TOOL

(71) Applicant: MARK C. MUNRO, BARRINGTON, IL (US)

(72) Inventor: MARK C. MUNRO, BARRINGTON, IL (US)

(21) Appl. No.: 16/023,078

(22) Filed: Jun. 29, 2018

Related U.S. Application Data
(63) Continuation of application No. 15/016,256, filed on Feb. 4, 2016, now abandoned.
(60) Provisional application No. 62/120,930, filed on Feb. 26, 2015.

(51) Int. Cl. G06Q 30/02; G06Q 50/00

(52) U.S. Cl. CPC G06Q 30/0282; G06Q 50/01; G06Q 30/0203

(57) ABSTRACT

A system and method for rating photographs and images is provided which evaluates the content of photographs and images as compared to reality and provides a standardized rating for the content which can be stored and accessed, and wherein the system can be programmed to provide comparative results and feedback to both website owners and content owners alike.

### CROSS-REFERENCE TO RELATED APPLICATIONS

This application is a continuation of application Ser. No. 15/016,256 filed Feb. 4, 2016, currently pending, which claims benefit of provisional Ser. No. 62/120,930 filed Feb. 26, 2015, now expired, the contents of each are incorporated by reference herein in their entirety, as if fully restated herein.

### FIELD OF THE INVENTION

The present invention relates to a photographic evaluation, rating system and assessment tool. More specifically, the invention relates to a system and method for evaluating the accuracy of a photographic depiction by comparison with reality, and providing a standardized rating related to the accuracy of each owner's content.

### BACKGROUND

With the advent of on-line advertising, websites employ photographic depictions to lure customers and clients to buy what they are selling. This is true for many different types of sales platforms including matchmaking websites, auto, and home sales, and rental websites, among others. Through browsing the photographs, the consumer makes initial and often final selections based on the photographs on the websites.

For example, with regard to buying a home there are numerous websites that a potential buyer can browse through while searching for a home that they would like to visit and evaluate in person. With so many photos of homes to view, this event can be overwhelming to the average consumer. There are many variables to consider and no set price standardization. A potential buyer will invest a substantial amount of time looking at homes. Moreover, buyers don't really know who to trust. Over 90% of today's buyers use online tools to prescreen their home searches and most will view a minimum of 15 homes before finding one worthy of an offer. The typical buyer's process is to quickly scan the online broker (or homeowner) supplied marketing photographs and specifications for a targeted search area and price point. On the strength of that information, the buyer then makes a determination on whether to visit and evaluate a home in person. Buyers can become frustrated and are frequently disappointed when the home is not accurately depicted in the photographs held out on the website as being illustrative of the home. Buyers often are fooled by enhanced photography that distorts room appearance, size, condition, and layout. Unfortunately, many buyers end up wasting their time and money chasing after homes that are not even close to their liking.

Similarly, on-line dating platforms allow members to view photographs of candidates who may be a possible match. Typically, the dating candidates themselves have uploaded their own photographs, which in many cases may be outdated and/or photo shopped and/or enhanced in some way. Quite often members are disappointed when they meet their date for the first time, realizing that the person has misrepresented their appearance through the outdated or altered photographs.

The rental market has also changed with the advent of on-line platforms that allow individual home owners to offer their apartments/homes for rent. Along with the publication, photographic depictions are provided. The photographic depictions allow a potential renter to assess the amenities of the rental property while deciding which property to rent among numerous choices. Most certainly a factor that weighs into the decision are the comments provided by previous renters. These are based on the experience in the rental property including whether the property amenities were actually as they were held out to be in the advertisement.

The used car market is another line of sales where on-line photographs are a useful tool for a buyer determining whether to make the journey to the dealership to view the automobile. Buyers browse the websites looking through numerous photographs of vehicles within their parameters including price, distance from their home, mileage, color, and the year of the vehicle, among other indicia. After making a decision based on the information obtained on-line, including photographs, the buyer will make the journey to the dealership to view the car. Unfortunately, potential buyers are often sorely disappointed when they discover that the on-line photograph is not entirely accurate or was taken at such an angle or in such lighting to mask flaws that would have otherwise have dissuaded a buyer from considering such a vehicle to begin with, thereby saving time in visiting a seller to see the vehicle.

These and other problems would not even exist if the photographs were accurate and correctly depicted, and more importantly, if the images had a standardized rating based on actual comparisons between the image and reality to tell a buyer, renter and/or match website subscriber whether the images are accurately depicting reality. Time would not be wasted travelling to visit locations, cars, or people that do not fall within a person's range of acceptable choices. In fact, a good standardized rating could provide content owners with more accurate depictions and market confidence, while at the same time encourage those content owners with consistently less accurate depictions to more accurately photograph or depict a particular space/home/person/car.

### SUMMARY OF THE INVENTION

The present invention is related to a tangible host system for evaluating and rating photographs and standardizing results, comprising a request module in communication with a content database, a content database in communication with a network of peers, with a remote evaluator system and the request module, whereby a request sent through the request module to the content database is responded to by the content database retrieving module with associated content and a standardized rating stored in the content database.

The present invention is also related to a tangible host system that allows a content owner to upload content to a database and upon creating a profile to designate a threshold level of ratings before an average rating can be published.

The present invention is further related to a tangible host system that provides a calculated standardized rating for content owned by a broker, an individual, a property owner, or a car seller.

The present invention moreover is related to a tangible host system that allows for subscribers to access content along with standardized ratings referring to the accuracy of the content.

The present invention is also related to a tangible host system that provides a tool with which subscribers can assess their own content accuracy as it compares to other subscriber's content accuracy in a similar subscription level.

The present invention is further related to a tangible host system that provides a tool by which a subscriber and/or a website owner can be apprised of and assess the accuracy of a content owner's depiction in the content uploaded to a website.

The present invention moreover is related to a tangible host system which provides a standardized rating which can be used for comparisons, data collection, advertising, marketing, and reliability.

The present invention is also related to a tangible host system whereby an evaluation can be done on-site with a target or remote from a target both in location and time.

The present invention is related to a tangible host system that provides anonymity during the evaluation process.

The present invention is related to a tangible host system whereby a subjective evaluation is standardized across a website, an industry and/or a salesperson base.

### BRIEF DESCRIPTION OF THE DRAWINGS

FIG. 1 illustrates an embodiment of the system in accordance with the principles of the present invention;

FIG. 2 illustrates an embodiment of a questionnaire in accordance with the principles of the present invention;

FIG. 3 illustrates a flow chart of an embodiment of the method of using the system in accordance with the principles of the present invention;

FIG. 4 illustrates an embodiment of a questionnaire in accordance with the principles of the present invention;

FIG. 5 illustrates a flow chart of an embodiment of the method of using the system in accordance with the principles of the present invention; and

FIG. 6 illustrates an embodiment of a questionnaire in accordance with the principles of the present invention.

### DETAILED DESCRIPTION OF THE DRAWINGS

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Further, it should be understood that, although steps of various claimed methods may be shown and described as being in a sequence or temporal order, the steps of any such method are not limited to being carried out in any particular sequence or order, absent an indication otherwise. That is, the claimed method steps are considered capable of being carried out in any sequential combination or permutation order while still falling within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. And that the term “or” denotes “at least one of the items,” but does not exclude a plurality of items of the list.

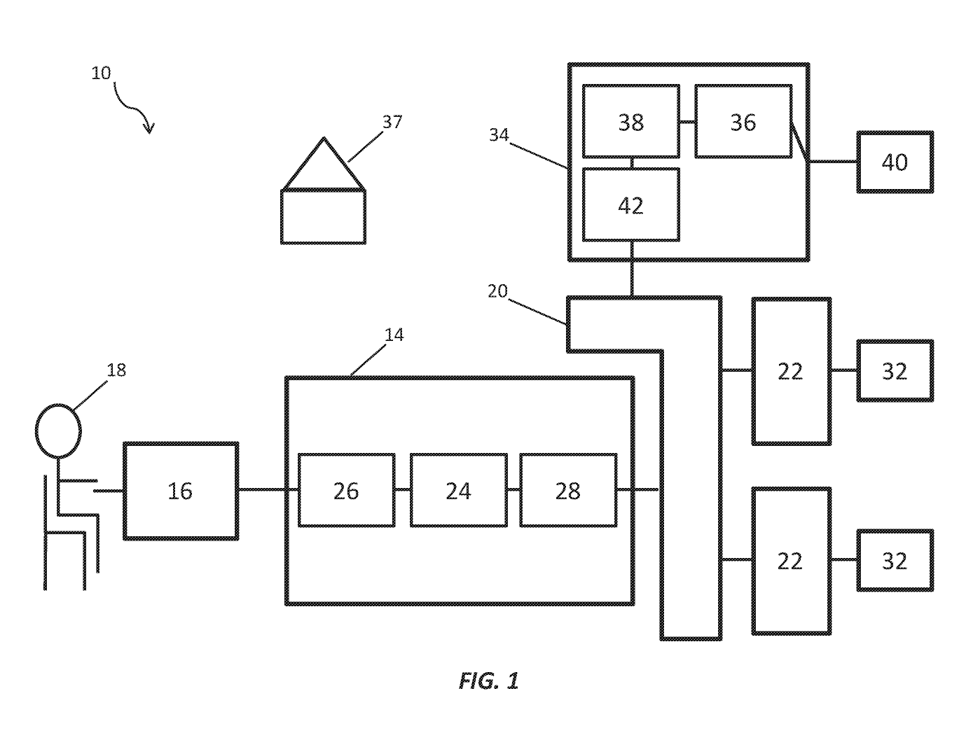

FIG. 1 illustrates a tangible host system 10 that evaluates and rates photographs, and standardizes the same. The host system 10 includes computer executable instructions, such as program code or program modules, that are executed by a computer or computing device. The computer or computing device can be any suitable computing system that can, for example, be understood by persons of skill in the art to be suitable for being connected to the host system 10 through a wired or wireless connection. Examples of such configurations include, but are not limited to, personal computers, laptop computers, computer servers, computer notebooks, hand-held devices, microprocessor-based systems, multiprocessor systems, programmable consumer electronics, cell phones, wrist watches, eyeglasses, personal digital assistants (“PDAs”), network PCs, minicomputers, mainframe computers, embedded systems, distributed computing environments, and the like.

The program code or modules of the host system 10 may include program objections, components, data elements and structures, routines, subroutines, functions and the like. These are used to perform or implement particular tasks or functions. Embodiments of the invention may be implemented in distributed computing environments, some tasks of the system are performed by remote processing devices which are linked via a communications network 20, or other data transmission medium, and data and program code or modules may be located in both local and remote computer storage media that may include memory storage devices.

As illustrated in FIG. 1, the system 10 includes a content database 14 and a request module 16. The request module 16 receives a request inputted by a user 18. The request module 16 also sends a request to the content database 14 and receives a response to the request from the content database 14, wherein the response may include a standardized rating. The request module 16 can further receive login credentials which are created by the user 18 to identify the user in the system 10, and which are sent to the content database 14 which stores the login credentials.

For example, the request module 16 includes a display and input devices such as touch-screen displays, a plurality of knobs, switches, buttons, etc. The display is, for example, a liquid crystal display (“LCD”), a light-emitting diode (“LED”) display, an organic LED (“OLED”) display, a thin-film transistor (“TFT”) LCD, etc.

The content database 14 is in communication with the request module 16. The content database 14 is preferably configured to store information such as content and associated content and standardized ratings, as well as login credentials and identifying criteria. The content database 14 is connected through a network 20 to a plurality of peers 22. The content database 14 in the embodiment illustrated in FIG. 1 is composed of a storing module 24, a retrieving module 26, and an association module 28, and can send a response to a request to the request module 16 for display to a user 18. The request module 16 can be implemented in any computer or computing device as above identified, known in the art to be appropriate for inputting and retrieving information, for being connected to a network such as the Internet, and having a display. Examples of computer or computing devices implementing the request module are personal computers, PDAs, and smart phones.

In some embodiments, the content database 14 includes, among other things, a processing unit. The processing unit is implemented using a known computer architecture, such as a modified Harvard architecture, a von Neumann architecture, etc. The processing unit of the content database 14 is connected by one or more control and/or data buses to the storing module 24, the retrieving module 26, and the association module 28. The use of one or more control and/or data buses for the interconnection between and communication among the various modules and components would be known to a person skilled in the art in view of the invention described herein.

Each peer 22 is connected to the content database 14 through a network 20, such as the Internet. A peer 22 is defined as a single point of input of identifying criteria and content by a content owner 32. The content owner 32 may be, for example, a real estate broker, an auto dealer, or a home owner. Each peer 22 can be any computer or computing device commonly understood in the art to be appropriate for inputting and retrieving information, for being connected to a network such as the Internet, and for displaying the expression of the system 10. Each peer 22 can receive content and identifying criteria inputted by a content owner 32, and each peer 22 thereafter sends the content and identifying criteria inputted by the content owner 32 to the content database 14 for storage in the storing module 24. The content inputted by the content owner 32 can be photographs, videos, digital images, and/or satellite photos, as examples. The storing module 24 also stores associated content and standardized rating information, after a rating module has performed a calculation to ascertain a standardized rating for a particular questionnaire 100 related to a target 37. Depending on the embodiment of the system 10, the target could be, but is not limited to, a property for sale, a person, a car, or a rental property.

The storing module 24 of the content database 14 can include combinations of different types of memory, such as read-only memory (“ROM”), random access memory (“RAM”), flash memory, a hard disk, an SD card, or other suitable magnetic, optical, physical, or electronic memory devices.

The system 10 may also include a remote evaluator system 34 in communication with the content database 14. The remote evaluator system 34 of the host system 10 has an input interface 36 in communication with the system 10. The input interface 36 could be the same computer or computing device which implements the request module 16, or could be a different computer or computing device from that of the request module 16, but can either way, access the host system 10 through a network 20, such as the Internet. The input interface 36 can be, but is not limited to, a mobile device such as a PDA, a smart phone, a tablet, or other type of portable computing device. The input interface 36 could also be, but is not limited to, a laptop, desktop or any personal computer.

The input interface 36 of the remote evaluator system 34 allows communication between an evaluator 40 and an evaluation module 38 of the evaluation system 34 of the host system 10, and provides an expression platform which allows an evaluator 40 to access the evaluation system 34 via the input of login credentials. An evaluator 40 could be, but is not limited to, a person other than the content owner 32 and/or a user 18. In some embodiments, the evaluator 40 can upload additional content (i.e., photographs) of a target 37 that was added to the system 10 by a different content owner 32.

The evaluation module 38 receives evaluator 40 login credentials in order to identify the evaluator 40 as a person other than the content owner 32.

The evaluator 40 login credentials provide information to the evaluation module 38 which dictates the type of questionnaire 100 selected by the evaluation module 38, and presented to the evaluator 40 through the input interface 36. The evaluator 40 inputs information into the selected questionnaire 100 through the input interface 36 in reference to the target 37. The questions on the questionnaire 100 will vary depending on the type of questionnaire 100 selected by the evaluation module 38. Each question on the particular questionnaire 100 will elicit a rating of between, for example, but not limited to, 0 and 5, 0 and 4, or 0 and 3, inputted by the evaluator. In an embodiment a “0” rating indicates that there was no photograph to rate in conjunction with a particular question.

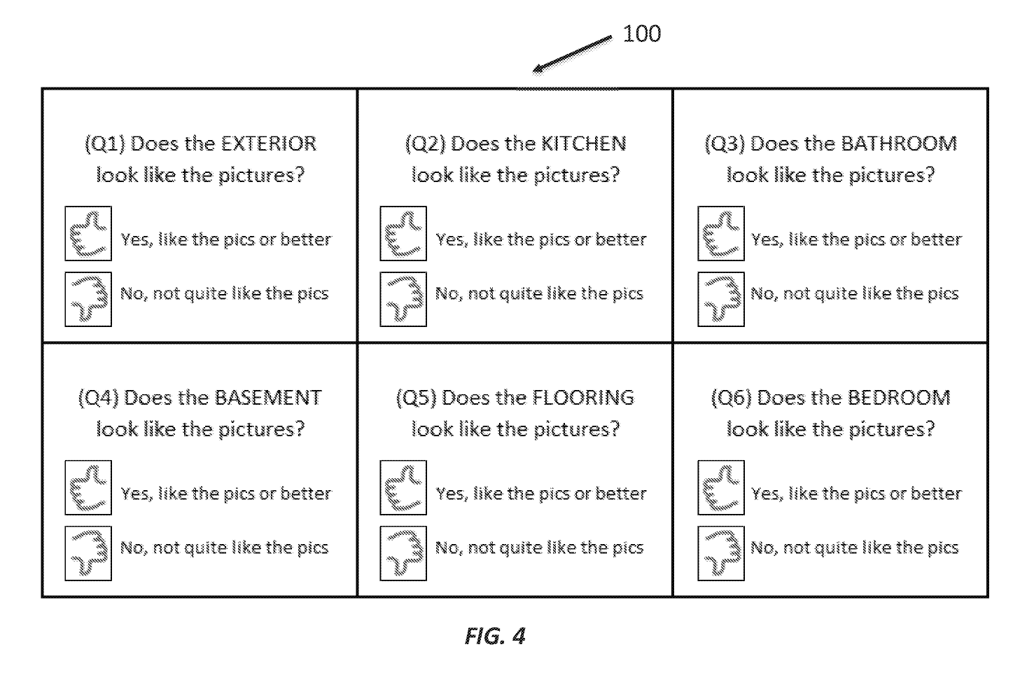

In some embodiments, the questionnaire 100 uses a thumbs up or down (i.e., binary) questionnaire 100 to elicit a rating (e.g., see FIG. 4). For example, if the evaluator 40 believes the content accurately depicts the target 37, a thumbs up is given; otherwise, a thumbs down is given. The simplified (e.g., thumbs up/down) questionnaire 100 may not provide as much detail in an evaluation as, for example, a numerical questionnaire 100 as described above. However, more evaluators 40 may complete a simplified questionnaire 100 because it may be quicker to complete.

In other embodiments, the remote evaluator system 34 provides both numerical questionnaires 100 and simplified questionnaires 100 to evaluators 40. Ratings may also be acquired from linked accounts (e.g., Facebook, Twitter, etc.). For example, the number of likes or shares of a post can be corroborated to a rating. The rating module 42 of the evaluator system 34 considers responses from both types of questionnaires 100.

The evaluation module 38 may also assign a unique identifier (e.g., a randomly generated number, an email address, etc.) to each questionnaire 100 selected and presented to an evaluator 40. The unique identifier identifies the particular questionnaire 100, which is presented for a particular target 37 and completed by a particular evaluator 40. Therefore the unique identifier will also identify the target address if for a property, or the target profile if for a person, or a target car if for an automobile. The evaluation module 38 stores the questionnaire 100 questions and the answers inputted by an evaluator 40, and stores associated unique identifier information, if any, along with the questionnaire 100. The evaluation module 38 can recognize completion commands by an evaluator 40 and can store the completed questionnaire 100. The questionnaire 100 need not be completed in a single input session by an evaluator 40. An incomplete questionnaire 100 can be retrieved from the system 10 through the evaluation module 38 upon request from an evaluator 40, after the evaluation module 38 identifies the evaluator 40 per the login credentials. The evaluation module 38 may also, upon login by an evaluator 40, retrieve and present incomplete questionnaires 100 to the evaluator 40, and recognize retrieval commands, thus retrieving an incomplete questionnaire 100 for retrieval and ultimate completion. A completed questionnaire 100 can either be stored in the evaluation module 38, but more preferably, is forwarded to a rating module 42.

The evaluation module 38 is also in communication with a rating module 42, also part of the remote evaluator system 34, and can further send completed questionnaire information including questions, answers, and any associated unique identifier information to the rating module 42.

The rating module 42 is in communication with the evaluation module 38 and also the content database 14. The rating module 42 receives completed questionnaires 100 from the evaluation module 38. The rating module 42 then calculates a standardized rating based on the answers supplied by the evaluator 40 regarding the target 37, and sends the standardized rating to the content database association module 28.

The rating module 42 calculates the standardized rating by adding the sum of the scores for all of the answers to the questions in the questionnaire 100, wherein each score has to be above zero “0” to be counted as a question/answer set, divided by (the number of questions times three). For example, if there are twelve questions and each has a possible rating of between 0 and 4, with zero being that no rating is possible because there is no photograph to review, then if each answer is in the extreme affirmative for each of the questions, then each answer will be four and the sum of the scores for all of the answers is twelve times four, or 12×4, which is 48. Thereafter, 48 is divided by (the number of questions times 3). So, the number of questions was 12 and 12 multiplied by 3 is 36. In this example, therefore the standardized rating is 48 divided by 36 or 1.33. The rating is therefore 1.33 for that target/content 37 and for that questionnaire 100.

In some embodiments, the standardization can include a weighted average. For example, if a variety of questionnaires 100 were completed—numerical ratings (e.g., 0 to 4), percentage ratings, thumbs up/down, etc.—the more detailed ratings can be given more weight in the standardized rating of the content. For example, answers from simplified questionnaire 100 can be weighted 75% of answers from a numerical questionnaire 100. In other embodiments, a completed questionnaire 100 is compared to other completed questionnaires 100 by the same evaluator 40 to determine a median rating given by the particular evaluator 40. Other statistical techniques would be known to a person skilled in the art in view of the invention described herein.

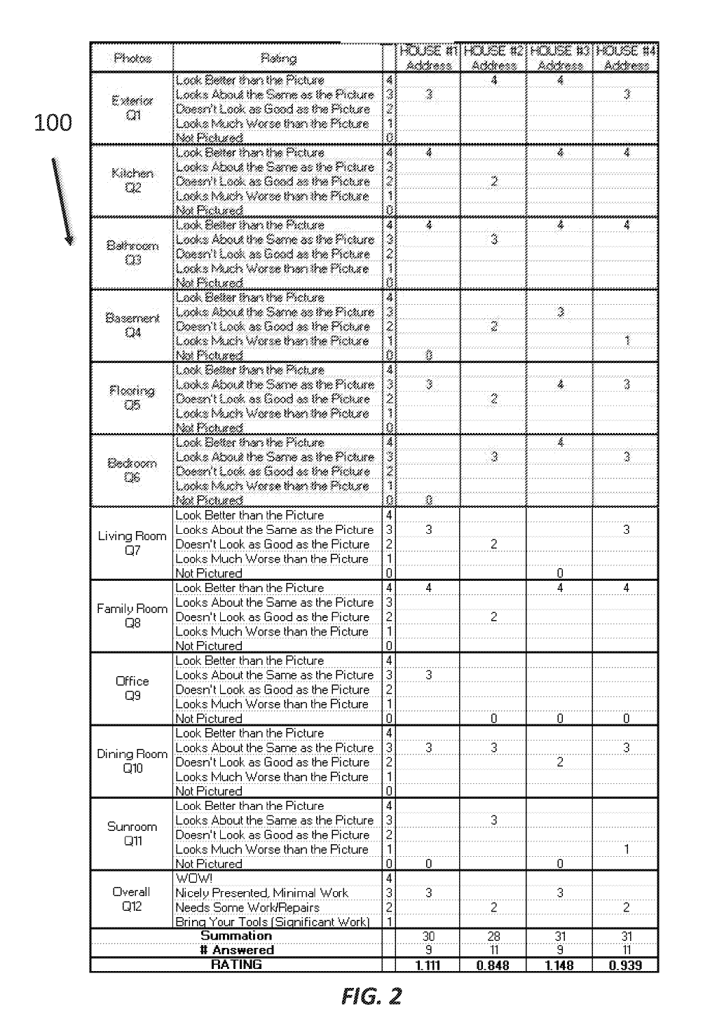

FIG. 2 illustrates an embodiment of a questionnaire 100 used in the method of this invention, and in this particular embodiment, the questionnaire 100 is for a target 37 which is a property. An embodiment of the rating module calculation is depicted in FIG. 2. FIG. 2 presents a list of questions, each with a possible 0 to 4 rating system, wherein “0” means that there was no picture to rate or that the question related to the picture was omitted by the evaluator 40, and “4” is the best possible rating of a picture and indicates that the photographic depiction exceeds the reality view of a feature of the target 37, e.g. bedroom. A rating of “3” indicates that the photographic depiction corresponds nearly perfectly with the reality of the feature of the target 37. There are 12 questions for which the sum total answer was 48, therefore generating a maximum rating of 1.33; a rating of at least 1.00 means the target 37 corresponds with the photographic depiction.

In some embodiments, the content owner 32 can tag the pictures being uploaded to the peer 22. The tag may include information about what room is depicted in the picture (e.g., kitchen, dining room, bedroom, etc.). The information from picture tags allows the remote evaluator module 34 to modify the questionnaire 100 by removing questions for which no picture exists (rather than asking the evaluator 40 input a 0).

The content database association module 28 is connected to the rating module 42 and receives a calculated standardized rating based on a questionnaire 100 with an associated unique identifier. The association module 28 is in communication with the storing module 24, which stores content inputted by the content owner. The association module 28 associates a standardized rating received from the rating module 42 based on a particular target 37 with a content stored in the content database storing module 24, and sends the association to the storing module 24, which can then store the association. Once a standardized rating is associated with a particular content, a user 18 may compare ratings of the content of different content owners by using the standardized rating system.

A content database retrieving module 26 of the system 10 is in communication with the requesting module 16 and the content database storing module 24. The content database retrieving module 26 of the system 10 retrieves stored content and stored associated standardized rating information from the content database storing module 24 and sends retrieved information in the form of a response to the request module 16 for ultimate display to the user 18. The retrieving module 26 filters retrieved information based on the request received by the request module 16 by the user 18, wherein the request can be refined based on a plurality of parameters, and therefore the retrieving module 26 can further filter the retrieved information, accordingly.

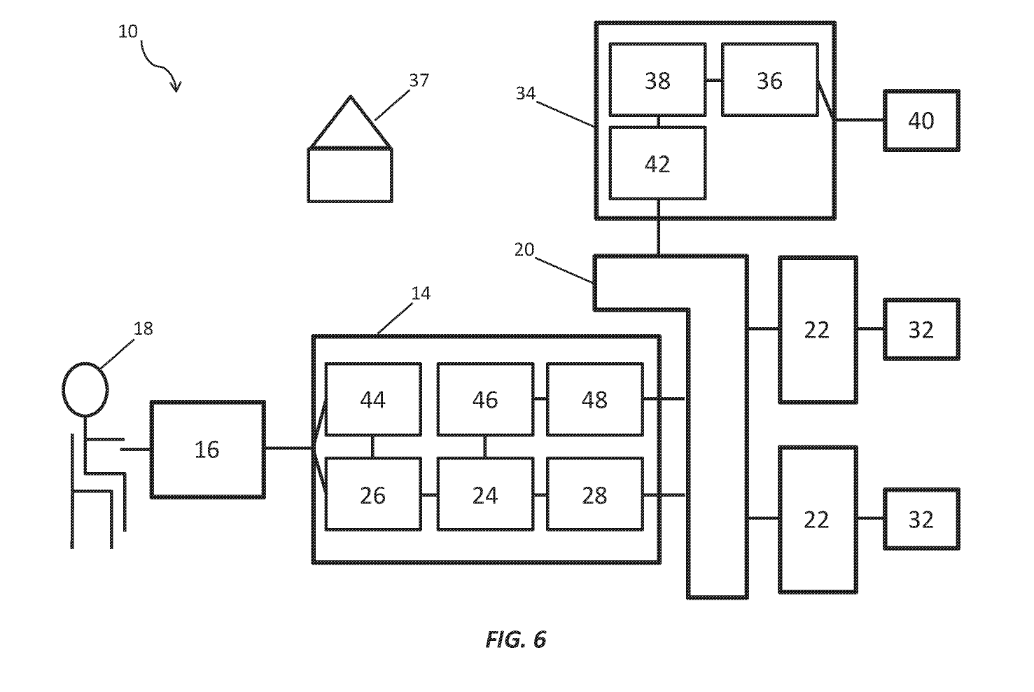

In another embodiment, shown in FIG. 6, the content database 14 includes a processing module 44 which can refine a response retrieved by the retrieving module 26 according to certain refined parameters input by a user 18. The content database processing module 44 may also send a predicted response to the request module 16 for display to the user 18. The predicted response can be generated based on the preferences the user 18 identified in the request, and is retrieved from the storing module 24 based on responses to previous requests with similar parameters or preferences by the same or other prior users. The predicted response is processed by the processing module 44. The processing module 44 can receive the user 18 request at the same time as the content database retrieving module 26 and can send the predicted response to the request module 16 for display to the user 18. The processing module 44 in an alternate embodiment may generate and send a predicted response merely upon the recognition of the user 18 via the login credentials, and without a request, but merely based on information stored from the user's 18 previous requests and login credentials.

FIG. 6 illustrates an embodiment of the system 10 wherein a processing module 44 is provided. The processing module 44 processes a response based on a refined request and/or provides a predicted response to the request. In the embodiment of FIG. 6, a market standing module 46 reviews the standardized ratings of subscribers/content owners and determines whether they are standardly in the range of standardized ratings for their particular market segment according to the subscription. This information can be accessed by a subscriber. In the embodiment of FIG. 6 a feedback loop 48 is connected to the market standing module 46 and the content owner login credentials. The feedback loop 48 can be enabled based on a threshold of information received by the market standing module 46. If a subscriber receives a threshold rating, which could be based on “n” number of ratings at “#” standardized rating, then the feedback loop 48 can be activated to send a message to the content owner/subscriber that the content is consistently lacking. This could provide a way to keep content owners/subscribers from consistently fooling the public with the content provided on the website. The feedback loop 48 can be actively included in the system 10 depending on the subscribers profile inputted by the subscriber upon subscribing, or in the alternative, the feedback loop 48 could always be active and routinely generate warnings to subscribers automatically if a particular threshold rating is received by a subscriber. In such an embodiment, should the system 10 automatically provide the feedback loop 48, the system 10 could also in another embodiment provide for automatic deactivation after a certain number of warnings are generated for a particular subscriber.

The feedback loop 48 may also send a message to the system or website owner to alert the same to the threshold ratings and warnings sent to a particular content owner to allow the website owner to deal with the content as they see fit. The feedback loop 48 could alert both the website owner and the content owner.

In some embodiments, the standardized ratings are made accessible to users 16. In other embodiments, the standardized ratings of the content may only be accessible to the content owner 32. The content owner 32 can use the private standardized ratings to make decisions about whether to remove content, use new photographs of the target 37, etc.

The following are some examples of embodiments of the system 10. These are merely examples and not intended to be exhaustive. It is understood by those skilled in the art that the system 10 could be achieved by different routes to the modules and with different software, coding, and programs. These examples are, therefore, merely illustrative.

### Example 1: Real Estate Photograph or Image Rating System

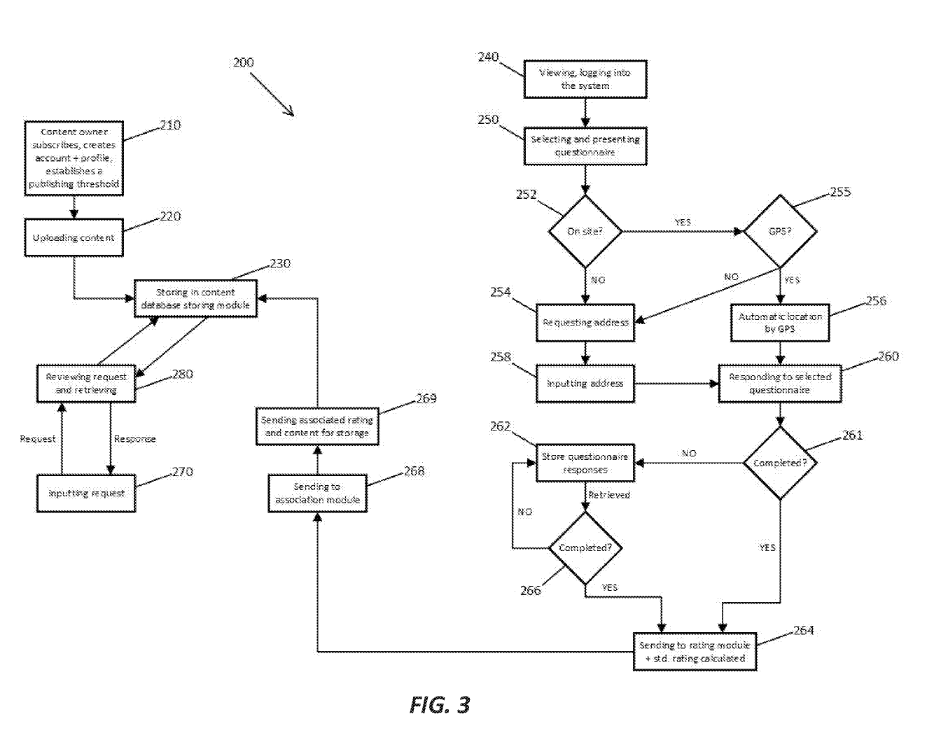

FIG. 3 is a flow chart 200 illustrating an embodiment of the method of using the system 10 of this invention. In FIG. 3, the content owner 32 is a real estate broker. In this embodiment illustrated in FIG. 3, the owner 32 upon signing in 210, if not already paid, pays a subscription fee in order to access the system 10 and upload content to the receiving module 30; inputs identifying criteria to create an account or a profile; and designates a threshold number of standardized ratings needed to generate a publishable standardized rating averaging the ratings after the threshold is met. In some embodiments, a subscription fee is not required to access the system 10, or there are multiple levels of memberships/subscription (with and without fees). Rather than a subscription with a monthly and/or yearly fee, a one-time license fee may be required to access the system 10. In yet other embodiments, the system 10 does not require any fees from subscribers, instead earning revenue through advertisement at the peers 22 and/or request module 16.

In another embodiment, the threshold number of standardized ratings necessary for generating a publishable standardized rating is set by the system 10. The threshold number may be variable depending on the type of questionnaires 100 answered by evaluators 40. For example, the system 10 may require 10 numerical (e.g., 0 to 4) questionnaires, 20 simplified (e.g., thumbs up/down) questionnaires, or a combination of questionnaires to be completed before generating a publishable standardized rating.

Next, the broker 32 uploads content to the peer 22 in step 220, such as photographs or images of a property within the subscription purchased. The subscription fee can be related to, but is not limited to, achieving standardized ratings for properties in a particular zip code or for properties within a particular price range.

In some embodiments, the content database 14 is a MLS (Multiple Listing Service) database, used by real estate brokers with a license/subscription. The host system 10 can be applied to real estate listings already available on the MLS database to create standardized ratings of the content (e.g., photographs) based on user 18 completion of questionnaires. In other embodiments, the content database 14 is an independent database for a specific brokerage. The independent database may include listings in a particular geographic area.

The request module 16 displays content from the content database 14 to the user 18, and the remote evaluator system 34 allows the evaluator 40 to complete questionnaires 100 evaluating how accurately the content depicts the target 37. In some embodiments, the request module 16 and evaluator system 34 are displayed in a website and/or application as embedded content. In other embodiments, the request module 16 and evaluator system 34 are accessible from a website and/or application through a link that opens a second website and/or application.

In the next step 230, once these photos or images are uploaded, the photos are sent by a peer 22 to the content database to be stored by and in the storing module 24.

Thereafter, an evaluator 40 goes on location to view the target 37 as in step 240, which in this example is a property for sale. Preferably, the evaluator 40 is a person other than the broker 32 who uploaded the content to the content database 14. For example, the evaluator 40 can be other brokers, the owner/seller of the house, and/or interested buyers. In one embodiment, the evaluator 40 can access the system 10 at the same time as viewing the target property 37 in order to evaluate the target property 37 in real time, in which case the evaluator 40 accesses the remote evaluation system 34 through the input interface 36 by a computer or computing device such as a smart phone or an iPad or a computer notebook on location and by searching for the system 10 and then logging into the system 10 by entering the evaluator 40 login credentials.

In an embodiment, the input interface 36 also has a global positioning system (“GPS”). A GPS is not necessary, but can provide additional information to the evaluation module 38 to confirm the location of the evaluator 40 at the property.

Thereafter, in step 250, the evaluation module 38, upon the evaluator 40 inputting login credential information, selects and presents the appropriate questionnaire 100 related to the login credentials, and automatically determines whether the input interface is GPS enabled. Often times, an evaluator 40 has a look at the target property 37 and either does not want to, does not have time to, or is unable to evaluate a target property 37 during the actual viewing. In this case, the evaluator 40 may review the target property 37 and thereafter evaluate the same from a location remote from the target property 37. Therefore, in order to implement such an embodiment of this example of the system 10, the evaluator 40 may use an input interface 36, a computer or computing device, to input login credentials, and thereafter, as in 252, the evaluation module 38 can send a question generated by the evaluation module 38 and posed to the evaluator 40 through the input interface 36 requesting that the evaluator confirm or deny that the evaluator 40 is located on the premises of the target property 37 via the input interface 36. If the evaluator 40 answers “no” then the response is registered by the evaluation module 38, which thereafter requests input from the evaluator 40 regarding the address being evaluated as in 254. The evaluator 40 then inputs the address manually 258. This information is processed by the evaluation module 38 and a questionnaire 100 selected and presented to the evaluator 40 is also tagged with the address of the target property 37 being evaluated by the questionnaire 100. Thereby, the evaluation module 38 is able to override the confirmation that the evaluator is at a particular target property 37 by GPS coordinates. Simply, if the evaluator 40 answers “yes” to the query as to location of the evaluator 40, then if in 250 the answer to whether there was GPS is “yes”, then 256 the questionnaire 100 is tagged with the address associated with the GPS coordinate automatically, whereas if in 250 the system 10 does not detect GPS coordinates, then the evaluator 40 is in 258 prompted to enter address information for the target property 37.

In other embodiments, information other than GPS coordinates is used to establish that the evaluator 40 has viewed the target property 37. For example, the content database may have information about who the evaluator has contacted (e.g., via phone, email, etc.) or whether a calendar appointment was made to view the target property 37. In yet other embodiments, the evaluation module 38 prompts the evaluator 40 to complete a questionnaire 100 if a target property 37 has been searched and/or viewed multiple times (e.g., more than five times within a week).

Once the evaluator 40 has accessed the system 10, and the system 10 has confirmed the identity of the evaluator 40 along with the identity of the target property 37, then the evaluation module 38 presents the appropriate questionnaire 100 to the evaluator 40. FIG. 4 is illustrative of a questionnaire 100 of the present example. This questionnaire is merely illustrative, and it should be understood that other layouts are entirely possible and contemplated for the system 10, and other questions are possible and contemplated by this system and example.

The questionnaire 100 presents a number of questions along with a range of possible ratings for each question, and the evaluator 40 answers each question in step 260. The questionnaire 100 in FIG. 4 has six questions, and each question has a possible answer of a thumbs up or down (i.e., binary). For example, if the evaluator 40 believes the content accurately depicts the target 37, a thumbs up is given; otherwise, a thumbs down is given. The simplified (e.g., thumbs up/down) questionnaire 100 may not provide as much detail in an evaluation as, for example, a numerical questionnaire as described above (see FIG. 2). However, more evaluators 40 may complete a simplified questionnaire 100 because it may be quicker to complete.

In other embodiments, a questionnaire 100 similar to the one depicted in FIG. 2 (e.g., with a 0 to 4 rating system) is used to elicit a rating, a rating is performed only including those questions that attain a rate of between “1” to the largest number, which in the example in FIG. 4 is “4”, and since there are a total of twelve questions, but since only ten could be answered with a number above 0, only 10 questions are used for preparing the sum of the ratings of the questions. This further standardizes the rating by accounting for the fact that each property has different features, for example wherein one property does not have a basement, a question related thereto could not possibly be answered because there would be no related picture, and such a question would receive a 0, but yet that question would not be included in the sum tallied, and would not skew the final rating. This allowance for differences in property features also enables a few general questionnaires 100 to be used by the system 10 for a broader range or number of properties, further illustrating the versatility and efficiency of the system 10.

Once the evaluator 40 inputs the answers to a questionnaire 100 as in 260, which has been awarded a unique identifier and tagged with property location information, the evaluator 40 will determine whether the questionnaire 100 is complete 261. The evaluator 40 can, if not complete 262 save the questionnaire 100 for later completion, or can submit the questionnaire 100, by indicating completion thereof as in 264, to the evaluation module 38. Alternatively, an embodiment of the invention provides that a questionnaire 100 must be completed in a single attempt. This latter embodiment could potentially provide for accurate results because it is assumed that the evaluation would occur if not on location, close in time to the on-location review of the target property 37, whereby opinions reflected in the answers on the questionnaire 100 may most accurately reflect the true opinion of the evaluator without interference from time, memory loss or enhancement.

Then in step 264, the evaluation module 38 sends a completed questionnaire 100 information 266 including the answers, location information, and associated unique identifier to the rating module 42 which then calculates a rating. The questionnaire 100 can be automatically sent or sent upon request by an evaluator 40. In the next step 268, once calculated, the rating module 42 sends the standardized rating of the questionnaire 100 for a property with a particular unique identifier to the association module 28. The association module 28 accesses the content stored in the storing module 24 and associates the appropriate content according to the address with which it is associated, via the content owner input, with the standardized rating awarded to a particular questionnaire 100 corresponding to a particular target property 37 location. The questionnaire 100 is tagged with information about the target property 37 when the system 10 identifies the evaluator 40 and the target property 37 for which the questionnaire 100 is being presented and answered. This information on the questionnaire 100 is used by the association module 28 to associate 268 the content in the storing module 24 with the standardized rating achieved by a particular questionnaire 100 related to a target property 37.

The associated information is then sent 269 to and stored in the storing module 24 as in step 230.

Upon a request in step 270, based on particular parameters inputted by a user 18, the request module 16 sends the request to the content database 14 wherein the content with an associated rating is stored. In the next step 280, when the user 18 sends a request, the retrieving module 26 of the content database accesses the requested content and sends a response including the requested content with the associated rating to the user 18. The user 18 may also subsequently request that the response be altered or refined using particular parameters and a subsequent refined request is sent to the retrieving module 26 which then, based on the refined request, responds with refined content with an associated standardized rating.

A user 18 can be the content owner 32 who uploaded the content into the content database 14 of the system 10. A user 18 can also be a person other than the content owner 32. A content owner cannot, however, be an evaluator. In one embodiment of this example of the system 10, the evaluator 40 is a person other than the content owner 32. The evaluator 40 can therefore input unbiased answers into the questionnaire 100 related to a particular target property 37, thereby providing the content owner with a rating for the content related to that target property 37.

A rating of 1.0 generated by this objective rating system illustrates that the content uploaded by a content owner 32 is illustrative of the real look and feel of the target 37. A rating of greater than 1.0 is generated if a target property 37 is actually better than the photos depict, and a rating of less than 1.0 is generated if a target property 37 is not as attractive as is depicted in the content photos or images. This rating system provides for an objective evaluation of the content owner's content.

In this system 10 in this example, a user 18 could be alerted to potential disappointment if a rating of less than 1.0 is generated for a target property 37 content retrieved in a search/request. This allows a user 18 to determine whether to spend time actually viewing a property in reality, or could prepare a user 18 for what lies in store in viewing a property.

This rating system could also be used by a content owner 32 for marketing and publicity purposes or to generate confidence in the content. If the content owner 32 consistently receives a rating of 1.0 for content supplied to the system 10, then the content owner can use this for advertising purposes, alerting the public to the honest presentation of the content and therefore the property features. Such easy reliance on the accurate depiction of the property could build confidence in a homebuyer or renter thus fostering a relationship or improving trust between a broker and a potential homebuyer.

An evaluator 40 in the present embodiment is the same as a user 18. The user 18 is requested to create log in credentials when entering the system 10, which identifies the user 18. Such information as to whether the user 18 is in the market for a new home, whether the user 18 is another broker, the name, username, and generated password, as well as other identifying indicia allows a profile to be generated for the user 18. In one embodiment, the user 18 could only be looking for a home through the system 10, and may never become an evaluator of content.

In another embodiment, however, if the user 18 wishes to view the target property 37 and evaluate the same, then the user 18 becomes an evaluator 40. In such an embodiment, the user 18 is requested to input credentials in order to identify the user 18. The user's 18 profile is retrieved by the system 10 from the request module. The user 18 can then alert the system 10 as to the desire to review a target property 37, as opposed to just searching and/or sending a request in the system 10. If the user 18 input is to begin an evaluation, then the user 18 is taken into the remote evaluation system 34. In such an instance, the user 18 becomes an evaluator 40, and can proceed to answer questions posed by the evaluation module 38 and to answer questions in a questionnaire 100 for a particular target property 37.

In some embodiments, the user 18 can be required to become an evaluator 40 in order to continue using the system 10. For example, if the system 10 has information indicating the user/evaluator 18, 40 has viewed the target property 37 it can require the user/evaluator 18, 40 to complete a questionnaire 100. Until the questionnaire 100 is complete, the user/evaluator 18, 40 has limited access to other listings and features.

This system 10, and this particular example of the system 10, and illustrated in the embodiment in FIG. 3, allows a content owner 32, a real estate broker, to have content evaluated by, for example, other real estate brokers or by independent reviewers, to generate an objective rating which could garner a level of trust regarding the content owned and in the system 10 by achieving good ratings, and potentially provide a marketing tool for generating more business. Therefore, a content owner 32 could re-enter the system 10 to get information related to (1) whether any ratings have been generated for the content, (2) whether the ratings are good and/or have reached the threshold publishable level, and/or (3) are generating traffic to a webpage, among other determinations. These and other information in an alternative embodiment could automatically be sent to the subscriber. A publishable rating would be established based on whether a threshold level of ratings have been met, and if yes, then an average rating calculated by the rating module.

The standardized ratings can be published with varying levels of detail. For example, in some embodiments, information about the number of completed questionnaires 100, the date of the most recently completed questionnaire 100, the highest and lowest questionnaire 100 result, and the standardized rating is published alongside the content. In other embodiments, only the standardized rating and count of completed questionnaires 100 is published. In yet other embodiments, the user 18 can access the standardized rating and individual questionnaire 100 results.

Moreover, this system 10 provides a way for homebuyers to evaluate the accuracy of the content retrieved in a response to a request. Furthermore, with the constant request for appraisals, this objective rating system could arm appraisal systems, evaluators, or appraisers with content (i.e. pictures and/or images) which have been awarded a rating, and to be able to use content which has achieved a rating of 1.0 in appraisals for more accuracy of the appraisal.

### Example 2: Photographic Rating System for Social Networking Website

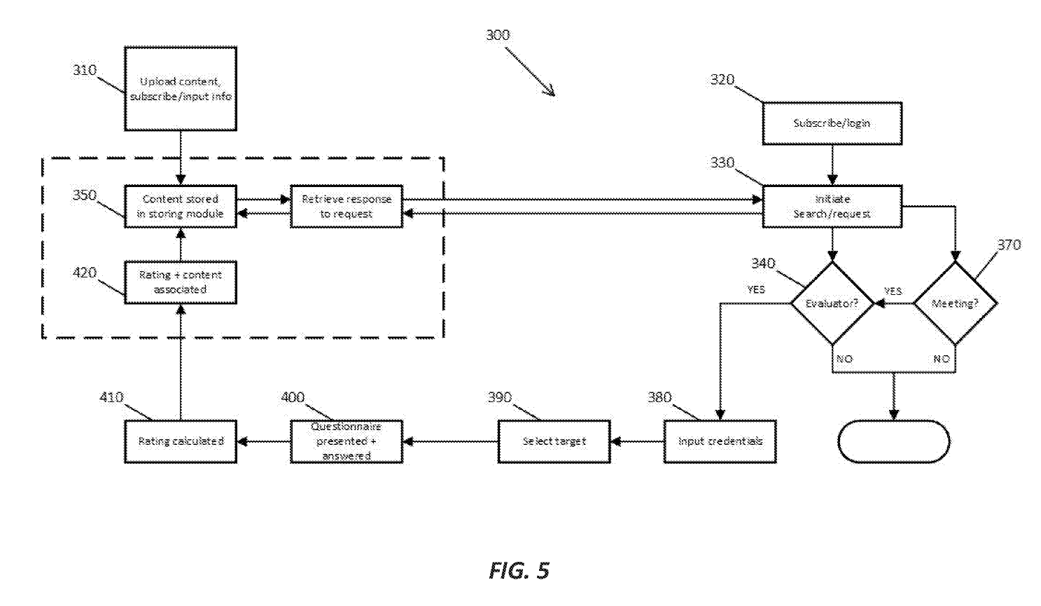

The system 10 can also be implemented in a method for rating images and utilizing the ratings on social networking websites, as in FIG. 5, an embodiment of the method for a social website. In this particular embodiment, in a first step 310, the content owner 32 is a person who is a subscriber of a social website (e.g., Facebook, Twitter, LinkedIn, etc.) or a dating website/application (Match.com, Tinder, Coffee Meets Bagel, etc.) and has uploaded content pictures of him/her self. In another step 320, a user 18 (also a subscriber) would either subscribe or identify him/herself as a subscriber and could initiate requests 330 to search the social website to arrange a meeting with a content owner 32 based on the results and content returned from a request. The user 18 could also base the decision on whether to meet a particular content owner 32 based on the standardized rating associated with the content. In order to generate a rating, the user 18 could input credentials into the system 10 and become an evaluator 340 after indicating as such in response to questions posed by the evaluation module 38.

Specifically, as shown in FIG. 5, the content owner 32 uploads pictures or images to the social membership website 310. Those pictures are stored 350 in the storing module 24 in the content database 14. Thereafter in step 360, after a user 18 initiates a search or request 330, then this request is sent through the request module 16 to the content database retrieving module 26 which then searches the content database for an appropriate response to the request and sends a response back to the user 18. The response can include content which has an associated rating or not.

A content owner 32 can choose to, in one embodiment for an additional fee, allow the content uploaded to be rated by the standardized rating system, in which case the content will be rated and a response to a request by a user 18 will appear along with a standardized rating, or in the alternative, the user 18 could request that only content that has a standardized rating be retrieved in the response to the request. Moreover, the user 18 could be interested only in receiving responses to the request including ratings within a certain range. This is not only true of the present example, but of the system 10 as it is expressed in other embodiments.

Thereafter 370 the subscriber/user 18 can chose whether to meet a particular content owner 32. If the user 18 chooses to meet with a content owner 32 (other member of the social networking website), the user 18 can choose to become an evaluator 40 and inputs into the system 10 identifying credentials 380 either during, or preferably after, a meeting. The evaluator 40 is then directed to a list of possible target people 37 to evaluate and is given the option to select one 390. If the content owner 32 has chosen to allow ratings of the photographic content uploaded and available on the website, then upon identifying the evaluator 40, the evaluation module 38 alerts the evaluator 40 that an evaluation is available by presenting a questionnaire 100. If not, then a questionnaire 100 is not presented, but rather a message relaying the same is presented to the evaluator 40 and the evaluation ends. In an alternative embodiment, the evaluator 40 can select targets 37 to meet and evaluate only from a list of proposed targets, each of which has indicated a willingness to have their content rated according to the system 10.

The evaluator 40 according to this example would then receive and complete 400 a questionnaire 100 with questions directed to for example the appearance of the content owner 32 and in-person meeting with the content owner 32. An embodiment of a questionnaire 100 that could be used in this example is similar to the questionnaire 100 illustrated in FIG. 2 and/or FIG. 4. Instead of rating photos of rooms (e.g., kitchen, bathroom, etc.), the evaluator 40 rates various photos of a person (e.g., face, profile, bust, whole body, etc.). The questionnaire 100 presents a list of questions, each with a possible 0 to 4 rating system, wherein “0” means that there was no picture to rate or that the question related to the picture was omitted by the evaluator 40, and “4” is the best possible rating of the photographic depiction corresponding with the reality view of a feature of the target 37, e.g. face.

A rating is calculated by the system 10 depicted in FIG. 6 for the questionnaire 100 in the embodiment. The same rating calculation would be performed 410 by the rating module 42, which receives the questionnaire 100 and associated answers from the evaluation module 38, along with the unique identifier. Once the rating is calculated, the rating for the questionnaire 100 and the unique identifier is sent to the association module 28. The rating is associated 410 via the association module 28 with the content and therefore the content owner. Thereafter, the associated information is sent to and stored in the storing module 24.

The accuracy and reliability of the content could easily remove some of the uncertainty regarding the accuracy of the content presented on the website. A rating of less than 1.0 could warn a user 18 that the picture or image associated with the content owner greatly outweighs the reality of the content owner's appearance. The system serves a plurality of purposes in this embodiment, therefore; keeping the content owner up to date and accurate with regards to the images uploaded on the website, apprising the website owner of the accuracy of the photos on the website and the content owners who are consistently accurate and vice versa, and/or providing invaluable information to the other members of the website as to the potential of a relationship with another person based on the images associated therewith.

### Example 3: Photographic Rating System for a Used Car Website

Similarly, the system and methods of the present invention could be applied to a website which offers for sale, used cars. In this example of the system 10, the content owner 32 would upload photographs or images of the vehicle for sale into the system 10. The content owner 32 would have to be an identified subscriber of the website, identified by identifying credentials input by the content owner 32. The content would then be transmitted to the storing module 24, where it is stored. A user 18 looking for a car would then access the system 10 by inputting login credentials and establishing an account or profile. Such information could be used when the user 18 eventually goes to view a target car 37 and inputs identifying information to become an evaluator 40. In this way a car for sale by a content owner car owner 32 can receive a rating from a questionnaire 100 filled by an evaluator 40. This rating can be associated via the system 10 with the content stored in the storing module 24, and stored therein so that other users 18 can assess the accuracy of the image or picture of the target car 37 via the rating associated therewith, helping with decisions on whether to make the effort to view a car on site if at all.

### Example 4: Photographic Rating System for Rental Properties on a Rental Website

Another example of the system 10 is for rating rental property content, for example for rental websites, wherein the content/rental property owner 32 uploads content (e.g., photographs, dimensions, etc.) to the content database storing module 24. Each rental property 37 is rated by an evaluator 40 who has stayed at the property previously, and the standardized rating created is associated with the content for that rental property for retrieval by a user 18 upon request.

In this way, a renter 18 will know whether the rental property 37 is actually the way it appears in the photographs and just gives added confidence in choosing the correct property to rent.

In addition to publishing the standardized ratings on rental websites, the system 10 may be in communication with social networking sites (e.g., Facebook, Twitter, LinkedIn, etc.) to publish standardized ratings in another location. A publication on a social networking site may include a link to the rental website along with the standardized ranking of the content, which increases interest in the rental property. In some embodiments, the content/rental property owner 32 can opt-out of the ratings (e.g., with permission from an administrator of the system 10).

As to the manner of usage and operation of the present invention, the same should be apparent from the above description. Accordingly, no further discussion relating to the manner of usage and operation will be provided.

While an embodiment of the system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tangible host system for evaluating and rating photographs and standardizing results, the system comprising:
a request module in communication with a content database, wherein the request module receives a request from a user, wherein the request is based on an input by the user, wherein the request is refinable based upon a plurality of parameters, and wherein the request module sends a request to the content database and receives a response to a request from the content database, wherein the response includes a standardized rating;
the content database comprising a storing module, a retrieving module, and an association module, and in communication with a network of peers, with a remote evaluator system and with the request module, that sends a response to the request for display through a display module to the user, receives a questionnaire 100 and associated information from the remote evaluator system, and receives content from a content owner through a network peer,
wherein the content database storing module stores content inputted by the content owner and associated standardized rating information,
wherein the content database retrieving module retrieves stored content and stored associated standardized rating information according to a request by a user, and wherein the content database associating module receives a standardized rating from a rating module of the remote evaluation system and associates a rating with a particular content stored in the content database;
a plurality of peers, wherein each peer is in communication with the content database, wherein each peer has a receiving module which receives content inputted by the content owner, and wherein the receiving module of each peer sends the content information inputted by the content owner to the content database, and wherein each peer receives identifying criteria of a content owner to identify the content owner and content information; and
a remote evaluator system in communication with the content database comprising:
an input interface in communication with an evaluator module and an evaluator, and allows an evaluator to access the evaluation system via the input of login credentials;
an evaluation module in communication with the input interface and a rating module, and which receives evaluator login credentials and location information, identifies a particular evaluator, selects a questionnaire type to present dependent upon evaluator login credentials and location information, assigns a unique identifier to the questionnaire selected, presents the questionnaire to an evaluator through the input interface, stores questionnaire information, questionnaire answers, and unique identifier information in connection with each questionnaire, and sends the questionnaire answers and information along with the unique identifier information to the rating module; and
a rating module in communication with the evaluation module and to the content database, and which retrieves answers and information for a questionnaire with unique identifier, calculates a standardized rating for the questionnaire with unique identifier, and sends the standardized rating to the content database association module.

2. The system as in claim 1, further comprising a processing module in communication with the request module and the content database retrieving module, which receives a refined request from the request module and processes a response from the retrieving module according to the refined request, and sends a refined request to the request module.

3. The system as in claim 1, further comprising a processing module in communication with the request module and the content database retrieving module, and which at the same time as a request is made by a user and sent to the content database retrieving module, via the request module, obtains and sends to the request module predicted responses from stored content in the content database storing module.

4. The system as in claim 1, wherein the content owner is also a subscriber, and further comprising a subscription system in communication with the content database, and wherein the subscription system accepts subscriptions associated with a particular subscriber, and records subscriber designations regarding how and when to display associated standardized rating and content information in response to requests, and is in communication with the content database retrieval module to display the associated standardized rating and content information as designated.

5. The system as in claim 4, wherein the subscriber is selected from the group consisting of a real estate broker, a member of the social networking site, a car owner, and a rental property owner.

6. The system as in claim 4, further comprising a market standing module in communication with the content database storing module and which reviews the standardized ratings associated with the content of a subscriber and compares the ratings to other subscribers from similar markets.

7. The system as in claim 6, further comprising a feedback loop in communication with the market standing module and the subscriber, and which triggers a communication to the subscriber when a threshold number of standardized ratings in a particular range is met.

8. The system as in claim 1, wherein the location information is selected from the group consisting of global position system (“GPS”) coordinates and a residential address.

9. The system as in claim 1, wherein the type of questionnaire is selected from the group consisting of a questionnaire for a home, for a person, for an automobile, and for a rental property.

10. A method for using a system to create and provide a standardized rating for content on a website offering properties for sale or rent, comprising the steps of:
creating a content owner account and profile for the website using identifying criteria, and sending the account and profile to a content database storing module of the system and storing therein;
uploading content to the content owner account and profile stored in the content database storing module;
storing the content in the content database storing module;
establishing a user profile by inputting and creating user login credentials in a request module of the system;
sending the user login credentials and user profile to the content database storing module and saving therein;
initiating an evaluation based on a user request through an input interface of the system affirming that the user will evaluate a target;
confirming the user identification based on login credentials and a location of the target;
presenting the questionnaire through the evaluation module of the system to the user through the input interface;
recording information in the evaluation module of the system including user responses to the questions on the questionnaire, the questionnaire selected questions, and the target address for the questionnaire and tagging the questionnaire with the information;
alerting the system to a completed questionnaire by sending a confirmation through the input interface to the evaluation module of the system, wherein the evaluation module sends the information of the completed questionnaire to a rating module of the system to calculate a standardized rating for a completed questionnaire each time a completed questionnaire is sent to a rating module, and wherein a calculated standardized rating is sent to an association module of the system to associate the standardized rating calculated for a questionnaire with a particular address and unique identifying information with content stored in the content database storing module having the same address associated therewith;
accessing stored associated rating and content through the system in response to requests thereby providing a system for creating and providing a standardized rating for content on a website.

11. The method as in claim 10, wherein the location of the target is selected from the group consisting of global position system (“GPS”) coordinates and a residential address.

12. The method as in claim 10, wherein providing the standardized rating for content on a website includes displaying information consisting from the group of the standardized rating, the standardized ratings, the number of completed questionnaires, and the date of the most recently completed questionnaire.

13. A method for providing a standardized rating for content on a social networking website, comprising the steps of:
creating a content owner account and profile for the website using identifying criteria, and sending the account and profile to a content database storing module of the system and storing therein;
uploading content to the content owner account and profile stored in the content database storing module;
storing the content in the content database storing module;
establishing a user profile by inputting and creating user login credentials in a request module of the system;
sending the user login credentials and user profile to the content database storing module and saving therein;
sending a request for the retrieval of content from the content database storing module via a retrieval module of the system, activating the system to retrieve content based on the parameters of the request from the content database storing module, and retrieving and proving the retrieved response to the user;
initiating an evaluation through an input interface of the system affirming that the user will evaluate a target whereby the system is activated to confirm user identification based on login credentials, and instructed to present eligible targets for evaluation, wherein the targets are selected from the group consisting of targets which the system has recorded as having agreed to be evaluated and targets that were retrieved by the retrieval module based on parameters inputted by the user in the request and in response to the user's request;
selecting a target to evaluate from the content database;
filling a questionnaire presented on the input interface related to the target;
alerting the system to a complete questionnaire by sending a confirmation through the input interface to an evaluation module of the system, wherein the evaluation module sends the information of the completed questionnaire to a rating module of the system to calculate a standardized rating for a completed questionnaire, and wherein a calculated standardized rating is sent to an association module of the system to association the standardized rating calculated for a questionnaire with unique identifying information including the name and identifying information for the target, with content stored in the content database storing module having the same target information stored therein; and
accessing the stored associated rating and content through the system in response to requests thereby providing a system to create and provide a calculated standardized rating for content on a website.

14. The method as in claim 13, further comprising storing an incomplete questionnaire in the evaluation module of the system for later retrieval and completion.
